(19) United States
(12) Patent Application Publication
(10) Pub. No.: US 2024/0257538 A1
(43) Pub. Date: Aug. 1, 2024

(54) SYSTEM AND METHOD FOR MONITORING A VEHICLE INTERIOR

(71) Applicant: Robert Bosch GmbH, Stuttgart (DE)

(72) Inventor: Hoang Trinh, Gerlingen (DE)

(21) Appl. No.: 18/538,223

(22) Filed: Dec. 13, 2023

(30) Foreign Application Priority Data
Jan. 31, 2023 (DE) 10 2023 200 752.5

(51) Int. Cl. G06V 20/59

(52) U.S. Cl. CPC G06V 20/597; G06V 20/593

(57) ABSTRACT

A system for monitoring a vehicle interior. The system includes at least one interface for receiving image data captured with an image capturing device, and a first computing device for providing at least a first monitoring function of the system based on the image data, and a further computing device for providing at least one further monitoring function of the system based on the image data. The system is designed in such a way that the image data are provided via the interface to the first computing device and that at least one portion of the image data is provided by the first computing device to the further computing device. The at least one portion of the image data includes image data that are required for the further computing device to provide the further monitoring function.

### CROSS REFERENCE

The present application claims the benefit under 35 U.S.C. § 119 of German Patent Application No. DE 10 2023 200 752.5 filed on Jan. 31, 2023, which is expressly incorporated herein by reference in its entirety.

### BACKGROUND INFORMATION

Driver monitoring systems, DMS, are generally described in the related art. The systems are typically one- or two- or multi-camera systems consisting of camera modules and active near-infrared lighting, IR modules.

Current developments also relate to interior camera systems that capture not only the driver but also the entire vehicle interior in order to be able to present further vehicle-safety-relevant functions, for example seat-occupancy detection, and also comfort-relevant functions.

### SUMMARY

One embodiment of the present invention relates to a system for monitoring a vehicle interior. According to an example embodiment of the present invention, the system comprises at least one interface for receiving image data captured with an image capturing device, and a first computing device for providing at least a first monitoring function of the system based on the image data, as well as a further computing device for providing at least one further monitoring function of the system based on the image data, wherein the system is designed in such a way that the image data are provided via the interface to the first computing device and that at least one portion of the image data is provided by the first computing device to the further computing device, wherein the at least one portion of the image data comprises image data that are required for the further computing device to provide the further monitoring function.

The captured image data are, for example, image data streams, for example comprising video data streams or single image data streams.

The image data are received via an interface, i.e., provided via the interface to the first computing device.

According to an example embodiment of the present invention, the computing devices are, for example, domain or zone control units, ECUs. Domain control units are used in a domain-specific E/E architecture, wherein they are classified by functions or functional areas. In a zone-oriented E/E architecture, the functions are distributed across domains onto zone control units depending on the arrangement in the vehicle. Both domain and zone ECUs must support a multitude of sensors and/or actuators in order to provide desired functions from the sensor information, e.g., safety functions and comfort functions.

In particular, the safety-relevant driver monitoring function for monitoring the driver's state of attention, for example drowsiness detection and/or distraction detection, requires very high computing power. It is therefore provided according to an example embodiment of present invention to provide the safety-relevant driver monitoring function by one computing device, for example the first computing device or the further computing device, and to realize further monitoring functions by the respectively other computing device. It is provided that only the image data required for the execution of the function are respectively transmitted from the one computing device to the other computing device. The forwarding of the image data by the first computing device to the further computing device thus takes place in a function-oriented manner. Through the forwarding of the image data by the first computing device to the downstream further computing device, further functions can be realized that would not be possible solely due to the limited resources, such as interfaces, bandwidth, performance, of the control units considered on their own.

According to one embodiment of the present invention, the system can comprise an image capturing device for capturing image data, in particular a camera, for capturing at least one portion of the vehicle interior, wherein the image capturing device is designed to provide the captured image data via the interface to the first computing device.

According to one embodiment of the present invention, it is provided that the first monitoring function and/or a further monitoring function, which can be provided with the first computing device, and/or the or a further monitoring function, which can be provided with the further computing device, is one of the following functions: a) a driver monitoring function, in particular for monitoring the driver's state of attention, in particular by capturing a body posture, a viewing direction and/or a position of a head or of a face or of the driver's eyes, an opening of the eyes, a blinking frequency of the driver's eyes, e.g., drowsiness detection, distraction detection, detection of vital signs of the driver, gesture detection; b) an occupant monitoring function, e.g., detection of vital signs of occupants, gesture detection, detection of activities in the vehicle interior, detection of situations in the vehicle interior, detection of the presence/absence of occupants in the vehicle interior, detection of the presence/absence of objects in the vehicle interior; c) videotelephony function; d) face detection function; e) intrusion detection in the vehicle interior.

The driver monitoring function(s) mentioned in a) are also referred to as DM(S), driver monitoring (system), function(s). The occupant monitoring function(s) mentioned in b) are also referred to as OM(S), occupant monitoring (system), function(s).

The first and/or the further control unit can also respectively provide several of the mentioned monitoring functions.

According to an example embodiment of the present invention, in a domain-specific E/E architecture, the first computing device is, for example, an ADAS control unit, advanced driver assistant systems, driver assistance system control unit. The first computing device provides, for example, driver monitoring functions, such as capturing a viewing direction and/or a position of a head, also referred to as eye tracking or head tracking, and/or drowsiness detection, and/or distraction detection. Additionally, or alternatively, the first computing device can also provide occupant monitoring function(s).

According to an example embodiment of the present invention, the further computing device is, for example, an in-vehicle infotainment (IVI) control unit. The further computing device provides, for example, monitoring functions such as a videotelephony function, face detection function and/or intrusion detection in the vehicle interior. Additionally, or alternatively, the further computing device can also provide occupant monitoring function(s).

The control unit cascade described can be advantageous since an alternative architecture with image capturing devices with image split functionality on both control units cannot be readily realized due to limiting factors such as interfaces, bandwidth, performance or customer-specific interface specifications.

According to one embodiment of the present invention, it is provided that the system is designed in such a way that output data based on processed image data are provided by the first computing device to the further computing device. Not only the forwarded image data but also processed output data, for example a detected face of the driver, can be used as input data for functions of the further computing device. Advantageously, it is thus possible to dispense with redundant processing of image data, the processing of which is relevant to the function of the further computing device but is already covered by a processing of the image data by the first computing device.

According to one embodiment of the present invention, it is provided that the system comprises a control device for controlling the image capturing device, and the image capturing device is designed in such a way that image data can be provided in at least two different contexts, wherein the system is designed in such a way that a respective context can be specified by means of the control device. The specification of the context takes place, for example, through a context-oriented configuration of an image sensor, also called an imager, of the image capturing device by means of the control device.

Further embodiments of the present invention relate to a method for operating a system for monitoring a vehicle interior according to the described embodiments, wherein at least a first monitoring function of the system based on the image data is provided with the first computing device, and at least a further monitoring function of the system based on the image data is provided with the further computing device. According to an example embodiment of the present invention, the method comprises the following steps:
providing image data via the interface to the first computing device, and providing at least one portion of the image data by means of the first computing device to the further computing device, wherein the at least one portion of the image data comprises image data that are required for the further computing device to provide the further monitoring function.

The forwarding of the image data by the first computing device to the further computing device takes place, for example, by transmission by means of Gigabit Ethernet, GiE. Beforehand, the first computing device can carry out a format conversion of the image data, for example into NV12 or YUV420, and an H.264 or H.265 encoding. The configuration conversion and the encoding can be adapted to limiting factors such as interfaces, bandwidth, image quality requirement, data rate, performance. The conversion makes it possible for the encoding of the image data to be carried out by a hardware encoder by means of memory-to-memory operation. The conversion can be carried out efficiently by either a corresponding processor or a hardware module. A maximum resolution and image refresh rate of the image data can be determined on the basis of the maximum pixel throughput of the hardware encoder. Where appropriate, the allowable data throughput of the image data can be adjusted by reducing the resolution either directly in the image sensor of the image capturing device or downstream. A constant bit rate in the provision of the image data can be advantageous in order to ensure robust, quasi-real-time transmission. For encoding, it can be advantageous to use only I-frames and no B or P-frames.

According to one embodiment of the present invention, it is provided that the method comprises: capturing image data by means of the image capturing device, in particular a camera, for capturing at least one portion of the vehicle interior.

It can be provided that the image capturing device comprises an image processor, also called an ISP chip, so that the color processing, such as noise suppression, white balance, color temperature correction, etc., of the captured image data can take place in the image capturing device. Alternatively, or additionally, the color processing can also take place by corresponding means in the first and/or the further computing device. In this case, the ISP chip in the image capturing device can be omitted.

According to one embodiment of the present invention, it is provided that the method comprises: providing output data based on processed image data, by means of the first computing device to the further computing device.

According to one embodiment of the present invention, it is provided that the method comprises:
specifying a context for providing the image data, by means of a control device for controlling the image capturing device, and providing the captured image data according to the specified context by means of the image capturing device. Advantageously, through corresponding actuation, the image capturing device provides image data in different contexts, for example in specified chronological order and/or for a specified time duration.

According to one embodiment of the present invention, it is provided that the first monitoring function of the first computing device and the at least one further monitoring function of the further computing device are performed at least temporarily simultaneously, and the image capturing device at least temporarily provides image data in a first context as a function of the first monitoring function, wherein, in the first context, the captured image data are output according to a first output format, and the image capturing device at least temporarily provides image data in at least one further context as a function of the further monitoring function, wherein, in the further context, the captured image data are output according to a further output format.

A respective output format comprises, for example, a resolution and/or a frame rate and/or, where appropriate, an image region. The respective output format is adjusted to a respective monitoring function in a function-oriented manner. The output format of a context can be different from the output format of another context in terms of resolution and/or frame rate and/or image region.

According to one embodiment of the present invention, it is provided that switching between the first context and the at least one further context takes place according to a pattern that can be specified as a function of the monitoring functions to be performed. The specifiable pattern comprises, for example, the order in which image data are provided in a respective context, and/or a duration for which image data are provided in a respective context.

According to one embodiment of the present invention, it is provided that at least one encryption method and/or authentication method is provided for securing the communication between the first computing device and the further computing device. For example, it can be provided that a TLS handshake method is carried out in order to protect the transmission of image data, in particular face data. TLS is an encryption and authentication protocol. A TLS handshake is the process that starts a communication session with TLS encryption. During a TLS handshake, the two communicating sides exchange messages in order to mutually acknowledge one another, mutually verify one another, determine the cryptographic algorithms they use, and agree session keys. Only after a successfully performed TLS handshake are the image data subsequently transmitted. An alternative or additional encryption method is, for example, scrambling the image data, in particular with the addition of randomly generated image portions. Alternatively, standard methods such as AES128 or AES256 or CSA common scrambling algorithm can also be used.

According to an example embodiment of the present invention, a further security measure provides that image data are transmitted in anonymized form, for example through redaction by censor bars or the like.

Further advantages arise from the description and the figures. Exemplary embodiments of the present invention are shown in the figures and are explained in more detail in the following description. In this respect, the same reference signs in different figures respectively refer to the same elements or to elements that are at least comparable in terms of their function. In the description of individual figures, reference is, where appropriate, also made to elements from other figures.

### BRIEF DESCRIPTION OF THE DRAWINGS

FIG. 1 shows a system for monitoring a vehicle interior, according to a first embodiment of the present invention.

FIG. 2 shows a vehicle interior.

FIG. 3 shows a system for monitoring a vehicle interior, according to a further embodiment of the present invention.

FIG. 4 shows a system for monitoring a vehicle interior, according to a further embodiment of the present invention.

FIG. 5 shows a system for monitoring a vehicle interior, according to a further embodiment of the present invention.

FIG. 6 shows a system for monitoring a vehicle interior, according to a further embodiment of the present invention.

FIG. 7 and FIG. 8 are different embodiments of an encryption method of the present invention.

### DETAILED DESCRIPTION OF EXAMPLE EMBODIMENTS

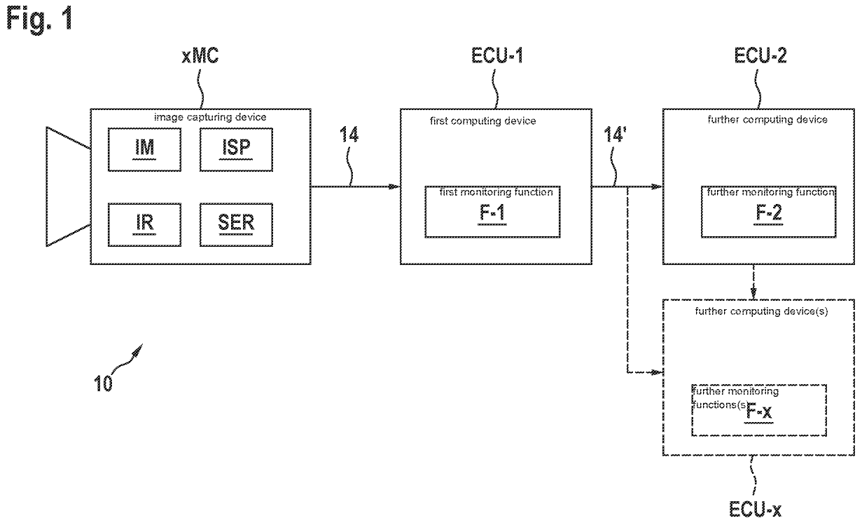

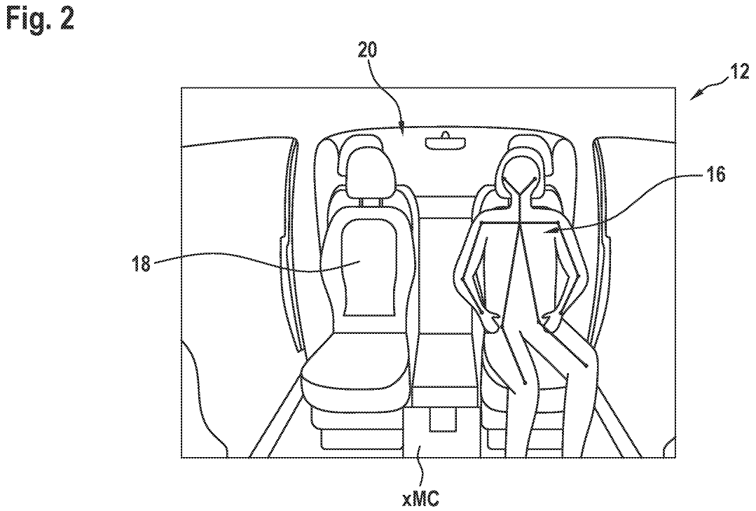

FIG. 1 shows a system 10 for monitoring a vehicle interior. An exemplary vehicle interior 12 is shown in FIG. 2. The vehicle interior is an interior of a motor vehicle. The motor vehicle can also be a semi-autonomous vehicle. By way of example, a driver 16 of the vehicle is shown in the vehicle interior 12. Further occupants (not shown) of the vehicle can be provided in a front passenger seat 18 and/or in the rear seat 20 of the vehicle.

In the example, the system 10 comprises an image capturing device xMC, in particular a camera, for capturing at least one portion of the vehicle interior 12 in the form of image data 14. The image data 14 are, for example, image data streams, for example comprising video data streams or single image data streams.

In the example, the image capturing device xMC comprises an image sensor IM, also called an imager, an image processor ISP, also called an ISP chip, an infrared module IR, and a serializer SER for serially transmitting image data 14.

The system 10 comprises a first computing device ECU-1 for providing at least a first monitoring function F-1 of the system based on image data 14 captured with the image capturing device xMC.

In the example, the system 10 comprises a further computing device ECU-2 for providing at least one further monitoring function F-2 of the system based on the image data 14 captured with the image capturing device xMC.

According to the example, the image data 14 captured with the image capturing device xMC are provided by the image capturing device xMC to the first computing device ECU-1 via a suitable interface, and at least one portion 14′ of the captured image data 14 is provided by the first computing device ECU-1 to the further computing device ECU-2, wherein the at least one portion 14′ of the captured image data 14 comprises image data that are required for the further computing device ECU-2 to provide the further monitoring function F-2.

The system can also comprise further computing devices ECU-x for providing further monitoring functions F-x. Image data can be forwarded by the first computing device ECU-1 and/or by the further computing device ECU-2.

According to the example shown, the image capturing device xMC is part of the system 10. This does not necessarily have to be the case. It may also be provided that the system comprises the computing devices ECU-1, ECU-2 and, where appropriate, further computing devices, wherein image data are provided via a suitable interface to the first computing device ECU-1. The image capturing device xMC is then not necessarily part of the system 10.

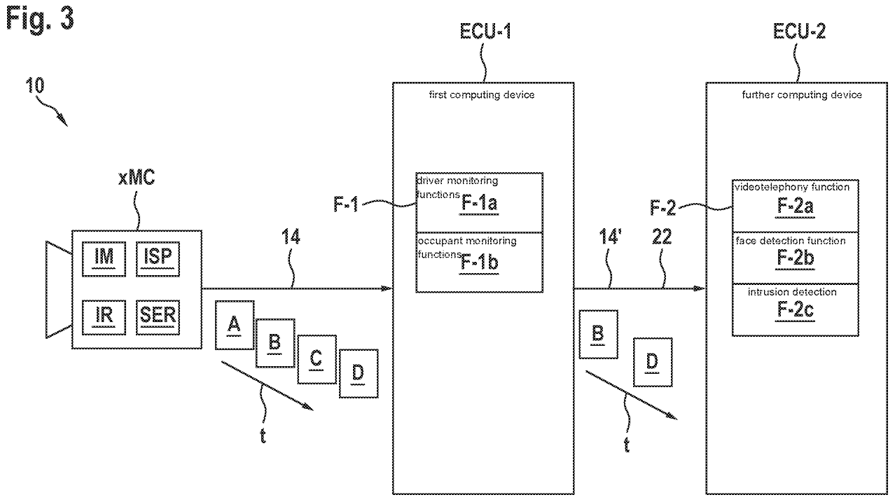

The first computing device ECU-1 is, for example, an ADAS control unit, advanced driver assistance systems, driver assistant system control unit. The first computing device ECU-1 provides, for example, driver monitoring functions F-la, such as capturing a viewing direction and/or a position of a head, also referred to as eye tracking or head tracking, and/or drowsiness detection, and/or distraction detection. According to the representation in FIG. 3, the first computing device ECU-1 also provides occupant monitoring function(s) F1-b.

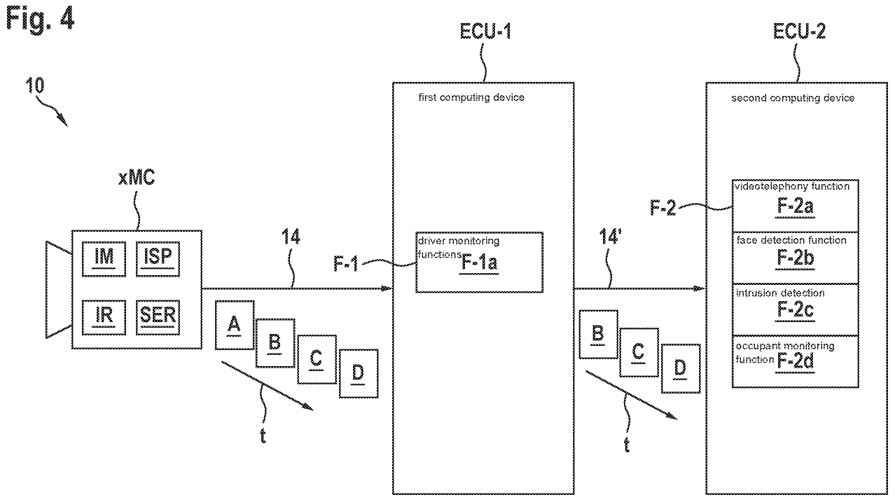

The further computing device ECU-2 is, for example, an in-vehicle infotainment (IVI) control unit. The further computing device ECU-2 provides, for example, monitoring functions F-2 such as a videotelephony function F-2a, face detection function F-2b and/or intrusion detection F-2c in the vehicle interior. According to the representation in FIG. 4, the further computing device ECU-2 also provides occupant monitoring function(s) F2-d.

According to one embodiment, it is provided that the system 10 is designed in such a way that output data based on processed image data 14 are provided by the first computing device ECU-1 to the further computing device. Not only the forwarded image data 14′ but also processed output data 22, for example a detected face of the driver, can be used as input data for functions of the further computing device ECU-2. Advantageously, it is thus possible to dispense with redundant processing of image data 14′, the processing of which is relevant to the function of the further computing device ECU-2 but is already covered by a processing of the image data 14 by the first computing device ECU-1.

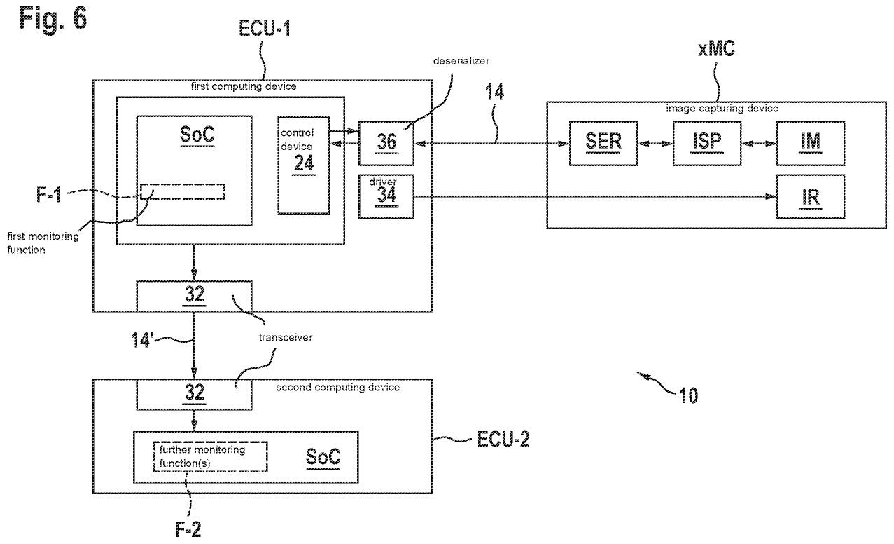

According to one embodiment, it is provided that the system 10 comprises a control device 24 for controlling the image capturing device xMC, and the image capturing device xMC is designed in such a way that image data 14 can be provided in different contexts A, B, C, D, wherein the system 10 is designed in such a way that a respective context A, B, C, D can be specified by means of the control device 24. The specification of the context takes place, for example, through a context-oriented configuration of the image sensor IM of the image capturing device xMC by means of the control device 24. According to the example, cf. FIG. 6, the control unit is realized in the first computing device ECU-1.

The context-oriented configuration of the image sensor IM and the provision of image data in different contexts A, B, C, D is explained on the basis of FIGS. 3 to 5.

The image sensor can, for example, provide a maximum resolution of 5.1 Mpix (2560×1980) at the frame rate of 60 Hz. The image sensor can advantageously be a CFA (color filter array) image sensor. The image sensor can, for example, be configured according to four different output formats, namely 1. RGBIR 4×4(raw), 2. IR upscaled, 3. IR ¼ of full resolution, 4. BGGR 2×2 Bayer (IR subtracted). The latter is an RGBIR processing which takes place inside the sensor and in which the RGBIR 4×4 Bayer matrix is converted to a BGGR 2×2 Bayer matrix and IR pixels replace adjacent color pixels RGB through interpolation. Alternatively, this processing does not have to take place inside the sensor but can also take place in the ISP chip.

In order to provide driver monitoring functions F-la, the first computing device ECU-1 needs, for example, image data in context A. In the example, image data in context A relate to a driver-related image section drvROI, for example the driver's head, with a resolution of, for example, 1.6 Mpix and a frame rate of, for example, 60 Hz, for example for monochrome IR image data.

According to an exemplary application, it is provided that at least for a certain time duration, a video call F-2a is to be carried out simultaneously by means of the further computing device ECU-2. For the videotelephony function F-2a, the further computing device ECU-2 requires, for example, image data in context B. In the example, image data in context B relate to a color video data stream in BGGR with a resolution of, for example, 3.7 Mpix and a frame rate of, for example, 24 Hz.

Switching between context A and context B can take place according to a specifiable pattern as a function of the monitoring functions to be performed. For example, the image data in context A and in context B can be provided by the image capturing device xMC according to a time division multiplexing method, for example according to a pattern A A B A A B or according to a pattern A B A B.

If an occupant monitoring function F-1b or F-2d is additionally to be provided by the first computing device ECU-1 or by the further computing device ECU-2, image data in context C are required, for example. In the example, image data in context C relate to image data with reduced VGA resolution and a frame rate of, for example, 10 Hz. An image section occROI can be directed toward the front passenger or toward fellow passengers in the rear seat, depending on the seat occupancy. For example, the image data in context A, in context B and in context C can be provided by the image capturing device xMC according to a time division multiplexing method, for example according to a pattern A A B A A C.

If a face detection F-2b is additionally to be provided by the further computing device ECU-2, image data in context D are required, for example. In the example, image data in context D relate to image data with a focused image region on the front passenger face, for example as a single image or as a video data stream with a low image refresh rate, e.g., is cycle. Focusing on the front passenger face can take place either by static determination or by dynamic detection of the face area, for example on the basis of skeleton detection and thus detection of the face position in the image.

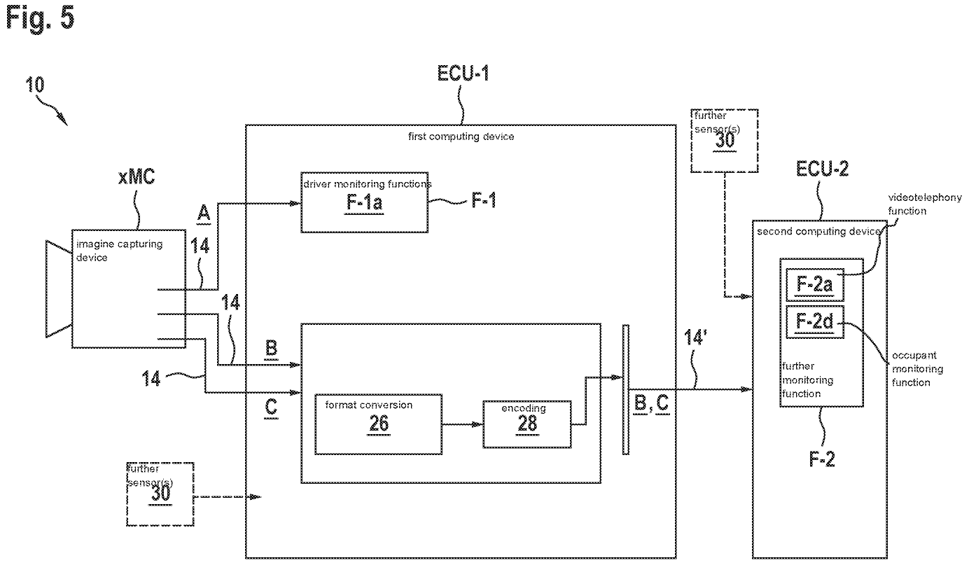

In the example in FIG. 5, image data in context B, C are forwarded by the first computing device ECU-1 to the further computing device ECU-2. For example, forwarding takes place by transmission by means of Gigabit Ethernet, GiE. Beforehand, the first computing device ECU-1 can carry out a format conversion 26 of the image data, for example into NV12 or YUV420, and an H.264 or H.265 encoding 28. The configuration conversion 26 and the encoding 28 can be adapted to limiting factors such as interfaces, bandwidth, image quality requirement, data rate, performance. The conversion 26 makes it possible for the encoding 28 of the image data to be carried out by a hardware encoder by means of memory-to-memory operation. The conversion 26 can be carried out efficiently by either a corresponding processor or a hardware module. A maximum resolution and image refresh rate of the image data can be determined on the basis of the maximum pixel throughput of the hardware encoder. Where appropriate, the allowable data throughput of the image data can be adjusted by reducing the resolution either directly in the image sensor of the image capturing device or downstream. A constant bit rate in the provision of the image data can be advantageous in order to ensure robust, quasi-real-time transmission.

According to the example, the first computing device ECU-1 and/or the further computing device ECU-2 can receive data from further sensors 30, which can be relevant to providing the respective functions.

FIG. 6 shows the system 10 according to a further representation. The first computing device ECU-1 and the further computing device ECU-2 comprise a GiE transceiver 32 in order to provide secured point-to-point Ethernet communication.

In addition to the components already described in the example, the first computing device comprises a driver 34 for the infrared module IR as well as a deserializer 36.

Various measures can be provided to secure the communication between the first computing device ECU-1 and the further computing device ECU-2.

For example, it can be provided that a TLS handshake method is carried out in order to protect the transmission of image data, in particular face data. TLS is an encryption and authentication protocol. A TLS handshake is the process that starts a communication session with TLS encryption. During a TLS handshake, the two communicating sides exchange messages in order to mutually acknowledge one another, mutually verify one another, determine the cryptographic algorithms they use, and agree session keys. Only after a successfully performed TLS handshake are the image data subsequently transmitted.

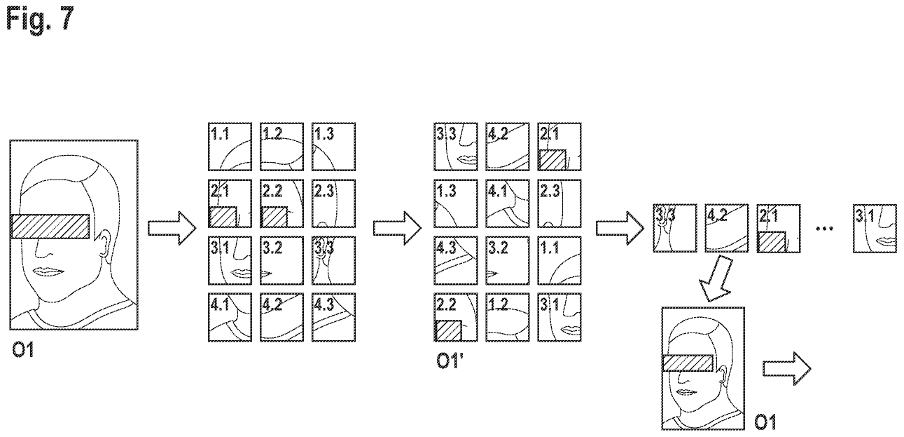

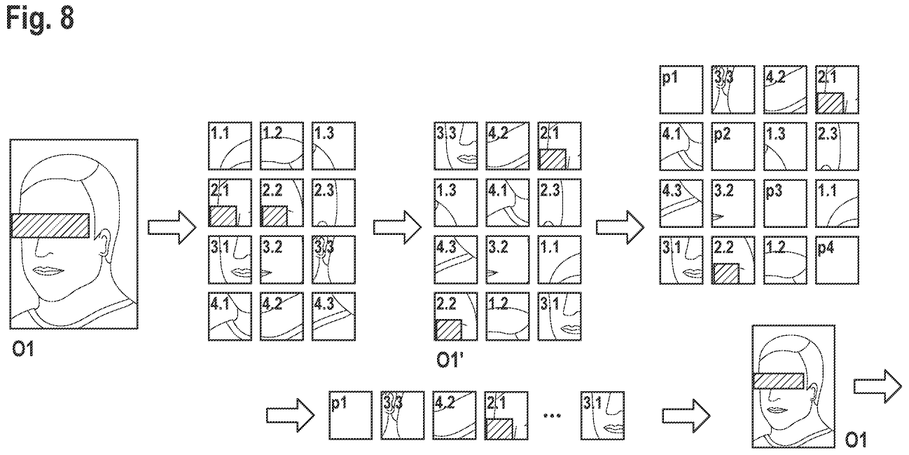

An alternative or additional encryption method is, for example, scrambling the image data, in particular with the addition of randomly generated image portions, cf. FIGS. 7 and 8. Alternatively, standard methods such as AES128 or AES256 or CSA common scrambling algorithm can also be used.

According to FIGS. 7 and 8, an original image O1 is divided into several sections 1.1 to 4.3. The sections 1.1 to 4.3 are re-arranged (scrambled) by means of lookup tables (LUT) so that a new image O1′ is generated. The sections are transmitted by the first computing device ECU-1 to the further computing device ECU-2 according to the arrangement in the image O1′. Subsequently, the sections are decrypted (descrambled) again by means of lookup tables (LUT) and are arranged according to the original image O1. According to FIG. 8, additional pseudo-image sections p1 to p4 are added and subsequently removed again.

A further security measure provides that image data are transmitted in anonymized form, for example through redaction by censor bars or the like. For example, a censor bar can be provided by default. It can be provided that the censor bar can be removed through a corresponding authorization, for example by the driver.

What is claimed is:

1. A system configured to monitor a vehicle interior, the system comprising:
at least one interface for receiving image data captured with an image capturing device;
a first computing device configured to provide at least a first monitoring function of the system based on the image data;
a further computing device configured to provide at least one further monitoring function of the system based on the image data;
wherein the system is configured in such a way that the image data are provided via the interface to the first computing device and that at least one portion of the image data is provided by the first computing device to the further computing device, wherein the at least one portion of the image data includes image data that are required for the further computing device to provide the further monitoring function.

2. The system according to claim 1, further comprising:
an image capturing device, configured to capture the image data, configured to capture at least one portion of the vehicle interior, wherein the image capturing device is configured to provide the captured image data via the interface to the first computing device.

3. The system according to claim 2, wherein the image capturing device includes a camera.

4. The system according to claim 1, wherein the first monitoring function and/or a further monitoring function which can be provided with the first computing device, and/or the further monitoring function of the further computing device, includes one of the following functions:
a) a driver monitoring function for monitoring a driver's state of attention, including by capturing: (i) a body posture and/or (ii) a viewing direction and/or (iii) a position of a head or of a face or of the driver's eyes, and/or (iv) an opening of the eyes, and/or (v) a blinking frequency of the driver, for drowsiness detection, and/or distraction detection and/or detection of vital signs of the driver and/or gesture detection;
b) an occupant monitoring function, for: (i) detection of vital signs of occupants, and/or (ii) gesture detection, and/or (iii) detection of activities in the vehicle interior, and/or (iv) detection of situations in the vehicle interior, (v) detection of the presence/absence of occupants in the vehicle interior, (vi) detection of the presence/absence of objects in the vehicle interior;
c) a videotelephony function;
d) face detection function;
e) an intrusion detection in the vehicle interior.

5. The system according to claim 1, wherein the system is configured in such a way that output data based on processed image data are provided by the first computing device to the further computing device.

6. The system according to claim 1, further comprising:
a control device configured to control the image capturing device;
wherein the image capturing device is configured in such a way that image data can be provided in at least two different contexts, and wherein the system is configured in such a way that a respective context can be specified using the control device.

7. A method for operating a system for monitoring a vehicle interior, the system being configured to monitor the vehicle interior, the system including:
at least one interface for receiving image data captured with an image capturing device,
a first computing device configured to provide at least a first monitoring function of the system based on the image data,
a further computing device configured to provide at least one further monitoring function of the system based on the image data;
the method comprising the following steps:
providing the image data via the interface to the first computing device; and
providing at least one portion of the image data using the first computing device to the further computing device, wherein the at least one portion of the image data includes image data that are required for the further computing device to provide the further monitoring function.

8. The method according to claim 7, wherein the method further comprises: capturing image data using the image capturing device, for capturing at least one portion of the vehicle interior.

9. The method according to claim 8, wherein the image capturing device includes a camera.

10. The method according to claim 7, wherein the method further comprises:
providing output data based on processed image data, using the first computing device to the further computing device.

11. The method according to claim 7, wherein the method further comprises:
specifying a context for providing the image data, using a control device configured to control the image capturing device, and providing the captured image data according to the specified context via the interface using the image capturing device.

12. The method according to claim 11, wherein the first monitoring function of the first computing device and the at least one further monitoring function of the further computing device are performed at least temporarily simultaneously, and the image capturing device at least temporarily provides image data in a first context as a function of the first monitoring function, wherein, in the first context, the captured image data are output according to a first output format, and the image capturing device at least temporarily provides image data in at least one further context as a function of the further monitoring function, wherein, in the further context, the captured image data are output according to a further output format.

13. The method according to claim 12, wherein switching between the first context and the at least one further context takes place according to a pattern that can be specified as a function of the monitoring functions to be performed.

14. The method according to claim 7, wherein at least one encryption method and/or authentication method is provided for securing communications between the first computing device and the further computing device.
